(19) United States
(12) Patent Application Publication
(10) Pub. No.: US 2017/0325076 A1
(43) Pub. Date: Nov. 9, 2017

(54) BASE STATION, USER TERMINAL AND APPARATUS

(71) Applicant: KYOCERA CORPORATION, Kyoto (JP)

(72) Inventors: Masato FUJISHIRO, Yokohama-shi (JP); Hiroyuki ADACHI, Kawasaki-shi (JP); Henry CHANG, San Diego, CA (US)

(73) Assignee: KYOCERA CORPORATION, Kyoto (JP)

(21) Appl. No.: 15/661,815

(22) Filed: Jul. 27, 2017

Related U.S. Application Data
(63) Continuation of application No. PCT/JP2016/052252, filed on Jan. 27, 2016.
(60) Provisional application No. 62/110,021, filed on Jan. 30, 2015.

(51) Int. Cl. H04W 4/06; H04W 88/08; H04W 88/02

(52) U.S. Cl. CPC H04W 4/06; H04W 88/02; H04W 88/08

(57) ABSTRACT

A base station comprises a processor and a memory coupled to the processor. The processor configured to execute processes of: transmitting to a user terminal, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission; receiving from the user terminal, interest notification including a first identifier corresponding to a first MBMS service which the user terminal is interested to receive, wherein the first MBMS service is determined by the user terminal based on the information; and transmitting, when the user terminal is handed over from the base station to another base station, the interest notification to the another base station.

### CROSS-REFERENCE TO RELATED APPLICATION

The present application is a continuation application based on PCT Application No. PCT/JP2016/052252 filed on Jan. 27, 2016, which claims the benefit of U.S. Provisional Application No. 62/110,021 (filed on Jan. 30, 2015). The content of which is incorporated by reference herein in their entirety.

### FIELD

The present invention relates to a base station, a user terminal, and an apparatus used in a mobile communication system.

### BACKGROUND ART

In the Third Generation Partnership Project (3GPP), which is a project aiming to standardize a mobile communication system, the specifications of Multimedia Broadcast Multicast Service (MBMS), as a technique for realizing multicast/broadcast transmission, have been laid out.

In the MBMS, a plurality of cells use a special subframe, called a Multicast-Broadcast Single-Frequency Network (MBSFN) subframe, and a plurality of cells belonging to an identical MBSFN area transmit identical multicast/broadcast data. A user terminal receives the multicast/broadcast data transmitted from the plurality of cells.

In the MBMS, in addition to the MBSFN subframe being used for the MBMS, it is difficult to dynamically change the MBSFN subframe, and thus, a radio resource may not be effectively used.

On the other hand, in order to realize multicast transmission while increasing the utilization efficiency of a radio resource, single-cell point-to-multipoint (SCPTM) transmission has been discussed. Unlike the MBMS to which multicast/broadcast transmission per MBSFN area is applied, multicast transmission per cell is applied to the SCPTM. Further, in SCPTM transmission, a case is assumed where a physical downlink shared channel (PDSCH) is used to transmit multicast data to a plurality of user terminals belonging to a group.

### SUMMARY

A base station according to a first aspect is a base station comprising a processor and a memory coupled to the processor. The processor configured to execute processes of: transmitting to a user terminal, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission; receiving from the user terminal, interest notification including a first identifier corresponding to a first MBMS service which the user terminal is interested to receive, wherein the first MBMS service is determined by the user terminal based on the information; and transmitting, when the user terminal is handed over from the base station to another base station, the interest notification to the another base station.

A user terminal according to a second aspect is a user terminal comprising a processor and a memory coupled to the processor. The processor configured to execute processes of: receiving from a base station, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission; determining, on the basis of the information, whether or not a first MBMS service which the user terminal is interested to receive is provided; and transmitting to the base station, interest notification including a first identifier corresponding to the first MBMS service upon determination that the first MBMS service is provided.

An apparatus according to a third aspect is an apparatus provided in a user terminal. The apparatus comprises a processor and a memory coupled to the processor. The processor is configured to execute processes of: receiving from a base station, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission; determining, on the basis of the information, whether or not a first MBMS service which the user terminal is interested to receive is provided; and transmitting to the base station, interest notification including a first identifier corresponding to the first MBMS service upon determination that the first MBMS service is provided.

### BRIEF DESCRIPTION OF THE DRAWINGS

FIG. 1 is a configuration diagram of an LTE system according to a first embodiment and a second embodiment.

FIG. 2 is a protocol stack diagram of a radio interface according to the first embodiment and the second embodiment.

FIG. 3 is a configuration diagram of a radio frame according to the first embodiment and the second embodiment.

FIG. 4 is a block diagram of a UE according to the first embodiment and the second embodiment.

FIG. 5 is a block diagram of an eNB according to the first embodiment and the second embodiment.

FIG. 6 is a diagram for describing SCPTM according to the first embodiment and the second embodiment.

FIG. 7 is a chart for describing operation patterns 1 and 2 according to the first embodiment.

FIG. 8 is a chart for describing an operation according to the second embodiment.

FIG. 9 is a diagram illustrating a GCSE network architecture.

### DESCRIPTION OF THE EMBODIMENT

### Overview of Embodiment

A typical service to which SCPTM is applied is group communication (for example, group call). In the group communication, multicast transmission is applied to downlink, and unicast transmission is applied to uplink.

As described above, the multicast transmission per cell is applied to the SCPTM, and thus, for example, if a user terminal moves from one cell to another cell, it is likely that in the other cell, the user terminal cannot perform desired group communication.

Thus, the present embodiment provides a base station and a user terminal by which it is possible to improve service availability of group communication.

A base station according to a first embodiment transmits multicast data to a plurality of user terminals belonging to a group performing a group communication. The base station comprises a transmitter configured to transmit a group list information to a user terminal in a cell of the base station, wherein the group list information includes group identifiers of each group to which a group communication is being provided by the cell.

In the first embodiment, the transmitter transmits the group list information in the cell by broadcast or unicast.

In the first embodiment, the group list information further includes information indicating a frequency on which a group communication corresponding to the group identifier is provided.

In the first embodiment, the group list information further includes information indicating whether or not a specific multicast manner is applied to a group communication corresponding to the group identifier. The specific multicast manner is a multicast manner of transmitting multicast data via a physical downlink shared channel.

In the first embodiment, the base station comprises a receiver configured to receive from a specific user terminal that has received the group list information, a group communication interest notification based on an interest in a group communication in the specific user terminal. The group communication interest notification includes a group identifier corresponding to a group communication in which the specific user terminal is interested.

In an operation pattern 1 of the first embodiment, the group communication interest notification is a notification indicating that a group communication in which the specific user terminal is interested is not provided.

In an operation pattern 2 of the first embodiment, the group communication interest notification is a notification indicating that a group communication in which the specific user terminal is interested is provided.

In the first embodiment, the base station comprises a controller configured to perform control to provide a group communication that the specific user terminal is interested to the specific user terminal in response to reception of the group communication interest notification.

A user terminal according to the first embodiment is a user terminal used in a mobile communication system that supports multicast transmission to a plurality of user terminals belonging to a group performing a group communication. The user terminal comprises a transmitter configured to transmit a group communication interest notification including a group identifier corresponding to a group communication in which the user terminal is interested, to the network. The transmitter transmits the group communication interest notification to the network even if there is no notification request from the network.

In the first embodiment, the user terminal further comprises a receiver configured to receives group list information transmitted from a serving cell or a neighboring cell. The group list information includes group identifiers of each group to which a group communication is being provided by a cell that transmits the group list information.

In an operation pattern 1 of the first embodiment, the user terminal further comprises a controller configured to determine whether or not a group communication in which the user terminal is interested is provided based on the group list information. The transmitter transmits the group communication interest notification upon determining that a group communication in which the user terminal is interested is not provided.

In an operation pattern 2 of the first embodiment, the user terminal further comprises: a controller configured to determine whether or not a group communication in which the user terminal is interested is provided based on the group list information. The transmitter transmits the group communication interest notification upon determining that a group communication to which the user terminal is interested is provided.

In the first embodiment, the network includes a base station that manages a serving cell of the user terminal. The transmitter transmits the group communication interest notification to the base station.

In a first modification of the first embodiment, the network is an apparatus different from the base station and includes a management apparatus that manages a group communication. The transmitter transmits the group communication interest notification to the management apparatus.

In the first modification of the first embodiment, the group communication interest notification further includes information indicating whether a specific multicast manner is applied to a group corresponding to at least one of a cell identifier of the serving cell and the group identifier. The specific multicast manner is a multicast manner of transmitting multicast data via a physical downlink shared channel.

A user terminal according to a second embodiment is a user terminal used in a mobile communication system that supports multicast transmission to a plurality of user terminals belonging to a group performing a group communication. The user terminal comprises a transmitter configured to transmit a connection request message for transitioning from an RRC idle mode to an RRC connected mode to the base station, and a controller configured to includes information on the group communication into the connection request message, in response to transitioning to the RRC connected mode in relevant to the group communication.

In the second embodiment, the connection request message includes a field indicating a connection reason. The controller includes information on the group communication into the field indicating the connection reason.

In the second embodiment, the information on the group communication is a group identifier corresponding to a group communication in which the user terminal is interested.

A base station according to the second embodiment is a base station used in a mobile communication system that supports multicast transmission to a plurality of user terminals belonging to a group performing a group communication. The base station comprises a receiver configured to receive from a user terminal a connection request message for the user terminal to transition from an RRC idle mode to an RRC connected mode; and a controller configured to perform control for the group communication when the information on the group communication is included in the connection request message.

### First Embodiment

Hereinafter, exemplary embodiments when the present disclosure is applied to an LTE system that is a mobile communication system based on the 3GPP standard will be described.

(Overview of LTE system)

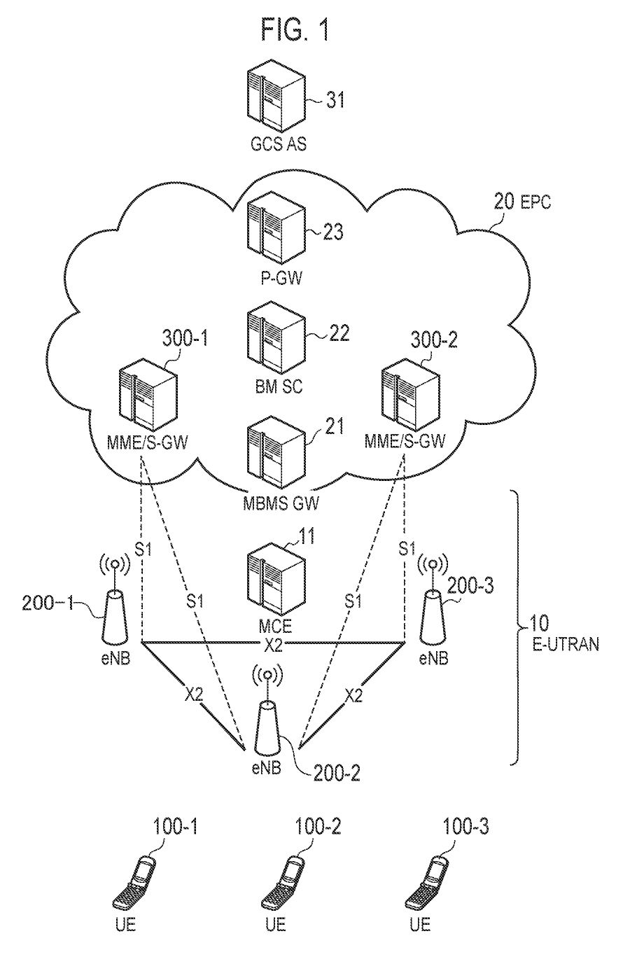

First, system configuration of the LTE system will be described. FIG. 1 is a configuration diagram of an LTE system.

As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell). Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data (hereinafter simply referred as “data”), and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer data. MME/S-GW 300 is connected to eNB 200 via an S1 interface. The E-UTRAN 10 and the EPC 20 constitute a network of the LTE system.

Moreover, the E-UTRAN 10 includes an MCE (Multi-Cell/Multicast Coordinating Entity) 11. The MCE 11 is connected to the eNB 200 via a M2 interface and is connected to the MME 300 via a M3 interface. The MCE 11 performs MBSFN radio resource management/allocation and the like.

The EPC 20 includes an MBMS GW (Multimedia Broadcast Multicast Service Gateway) 21. The MBMS GW 21 is connected to the eNB 200 via a M1 interface, connected to the MME 300 via a Sm interface, and connected to a BM-SC 22 (described later) via a SG-mb interface and a SGi-mb interface. The MBMS GW 21 performs IP multicast data transmission and session control to the eNB 200.

The EPC 20 also includes a BM-SC (Broadcast Multicast Service Center) 22. The BM-SC 22 is connected to the MBMS GW 21 via the SG-mb and SGi-mb interfaces, and is connected to the P-GW 23 via the SGi interface. The BM-SC 22 mainly manages and allocates TMGI (Temporary Mobile Group Identity).

Further, a GCS AS (Group Communication Service Application Server) 31 is provided in a network (i.e., the Internet) outside the EPC 20. The GCS AS 31 is an application server for group communication. The GCS AS is connected to a BM-SC 22 via a MB2-U interface and a MB2-C interface, and is connected to a P-GW 23 via a SGi interface. The GCS AS 31 performs group management and data distribution (including determination of whether to use MBMS or whether to use unicast) in group communication and the like.

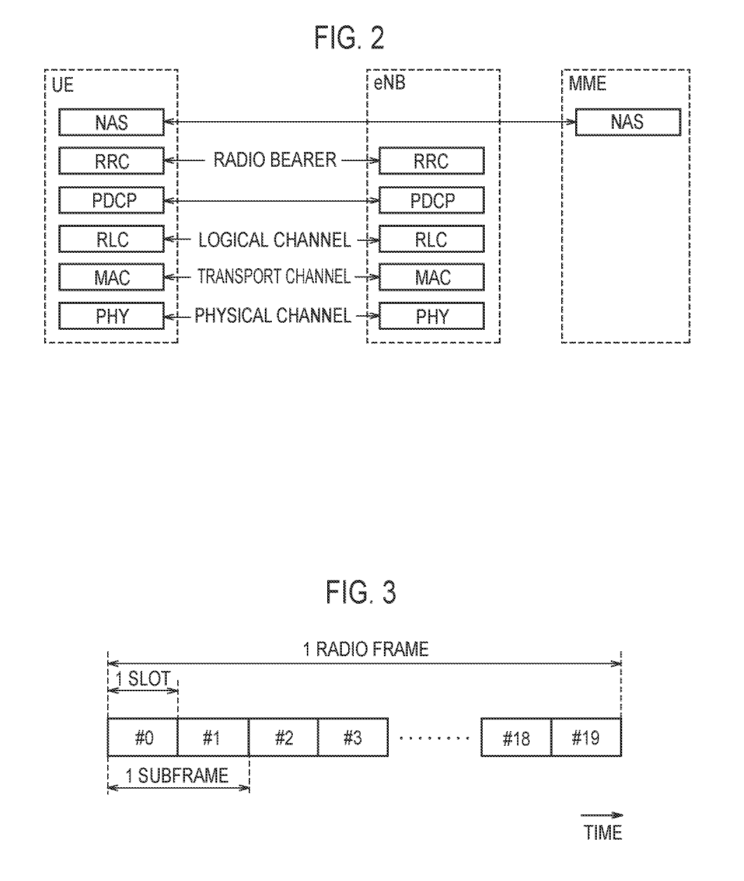

FIG. 2 is a protocol stack diagram of a radio interface in the LTE system. As illustrated in FIG. 2, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data and control signal are transmitted via the physical channel.

The MAC layer performs priority control of data, a retransmission process by hybrid ARQ (HARQ), and a random access procedure and the like. Between the MAC layer of the UE 100 and the MAC layer of the eNB 200, data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, message (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected mode, otherwise the UE 100 is in an RRC idle mode.

A NAS (Non-Access Stratum) layer positioned above the RRC layer performs a session management, a mobility management and the like.

FIG. 3 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 3, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction (not shown), and a plurality of symbols in the time direction. Each resource block includes a plurality of subcarriers in the frequency direction. One symbol and one subcarrier forms one resource element. Of the radio resources (time and frequency resources) assigned to the UE 100, a frequency resource can be identified by a resource block and a time resource can be identified by a subframe (or a slot).

In the downlink, a section of several symbols at the head of each subframe is a control region used as a physical downlink control channel (PDCCH) for mainly transmitting a control signal. Furthermore, the other portion of each subframe is a region available as a physical downlink shared channel (PDSCH) for mainly transmitting downlink data. Furthermore, in each subframe, a downlink reference signal such as a cell specific reference signal (CRS) is arranged.

In the uplink, both ends in the frequency direction of each subframe are control regions used as a physical uplink control channel (PUCCH) for mainly transmitting an uplink control signal. Furthermore, the other portion of each subframe is a region available as a physical uplink shared channel (PUSCH) for mainly transmitting uplink data. Furthermore, in each subframe, an uplink reference signal such as a sounding reference signal (SRS) is arranged.

(Configuration of UE 100)

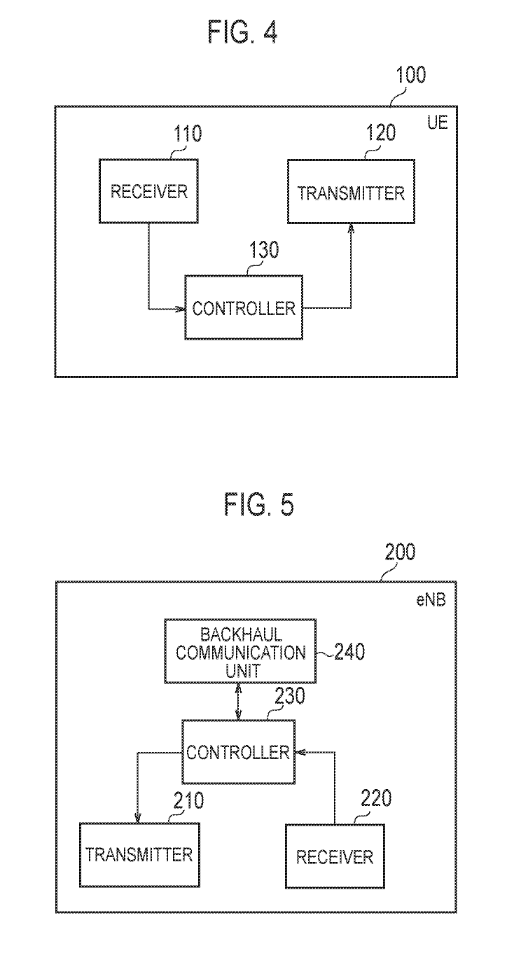

FIG. 4 is a block diagram of a configuration of the UE 100 (user terminal). As illustrated in FIG. 4, the UE 100 includes a receiver 110, a transmitter 120, and a controller 130.

The receiver 110 performs various types of reception under the control of the controller 130. The receiver 110 includes an antenna and a receiving machine. The receiving machine converts a radio signal received by the antenna into a baseband signal (reception signal) and outputs it to the controller 130.

The transmitter 120 performs various types of transmission under the control of the controller 130. The transmitter 120 includes an antenna and a transmitting machine. The transmitting machine converts a baseband signal (transmission signal) output from the controller 130 into a radio signal and transmits it from the antenna.

The controller 130 performs various controls in the UE 100. The controller 130 includes a processor and a memory. The memory stores programs executed by the processor and information used for processing by the processor. The processor includes a baseband processor that performs modulation and demodulation of the baseband signal, performs encoding and decoding, and the like, and a CPU (Central Processing Unit) that executes various programs by executing a program stored in the memory. The processor may include a codec for encoding/decoding audio/video signals. The processor executes various processes described later and various communication protocols described above.

The UE 100 may comprise a user interface and a battery. The user interface is an interface with a user possessing the UE 100, and includes, for example, a display, a microphone, a speaker, various buttons, and the like. The user interface receives an operation from the user and outputs a signal indicating the content of the operation to the controller 130. The battery stores electric power to be supplied to each block of the UE 100.

(Configuration of eNB 200)

FIG. 5 is a block diagram of the eNB 200 (base station). As illustrated in FIG. 5, the eNB 200 includes a transmitter 210, a receiver 220, a controller 230, and a backhaul communication unit 240.

The transmitter 210 performs various transmissions under the control of the controller 230. The transmitter 210 includes an antenna and a transmitting machine. The transmitting machine converts a baseband signal (transmission signal) output from the controller 130 into a radio signal and transmits it from the antenna.

The receiver 220 performs various types of reception under the control of the controller 230. The receiver 220 includes an antenna and a receiving machine. The receiving machine converts a radio signal received by the antenna into a baseband signal (reception signal) and outputs it to the controller 230.

The controller 230 performs various controls in the eNB 200. The controller 230 includes a processor and a memory. The memory stores programs executed by the processor and information used for processing by the processor. The processor includes a baseband processor that performs modulation and demodulation of the baseband signal, performs encoding and decoding, and the like, and a CPU (Central Processing Unit) that executes various programs by executing a program stored in the memory. The processor executes various processes described later and various communication protocols described above.

The backhaul communication unit 240 is used for backhaul communication with other eNB 200s and the aforementioned network entity.

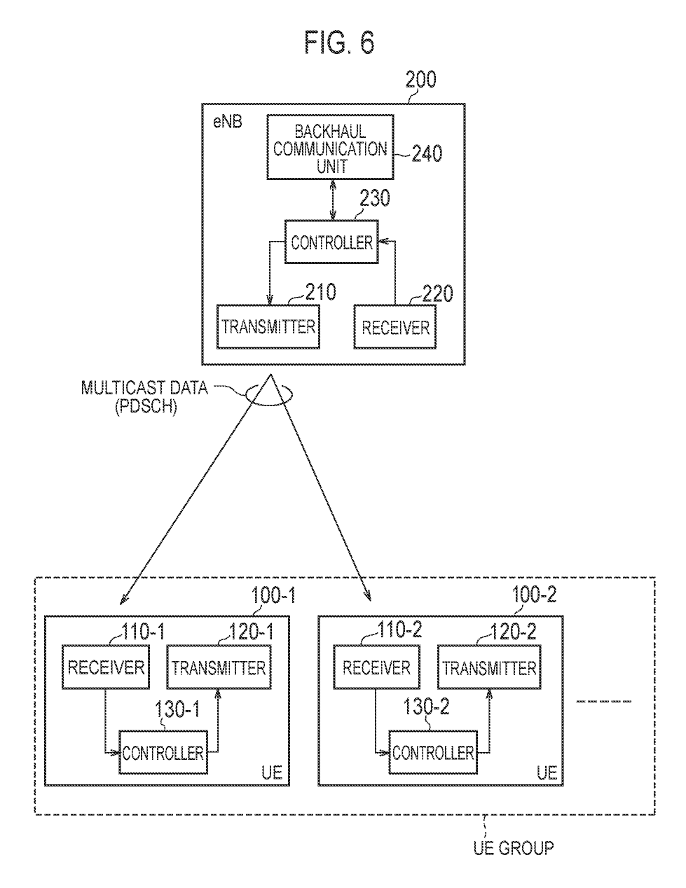

(Overview of single-cell PTM transmission) Below, single-cell PTM transmission (SCPTM) will be described. With the SCPTM, multicast transmission is realized while increasing the utilization efficiency of a radio resource. FIG. 6 is a diagram for describing an SCPTM-related operation according to the first embodiment.

As illustrated in FIG. 6, in the SCPTM, the eNB 200 uses the PDSCH to transmit multicast data by a single cell. That is, unlike the MBMS to which multicast/broadcast transmission per MBSFN area is applied, multicast transmission per cell is applied to the SCPTM.

A plurality of UEs 100 (UE 100-1, UE 100-2 . . . ) configured to receive identical multicast data configure a UE group. Each UE 100 in the UE group is assigned with a common group identifier. The group identifier is, for example, a temporary mobile group identity (TMGI) or a group radio network temporary identifier (RNTI). The group identifier is assigned by the eNB 200 (or the MCE 11). Alternatively, the group identifier may be assigned by an entity of the core network (EPC 20). Alternatively, the group identifier may be assigned by an application server (GCS AS 31, for example).

A typical application to which the SCPTM is applied is group communication (group call service, for example). In the group communication, multicast transmission is applied to downlink, and unicast transmission is applied to uplink. It is noted that the group communication may be provided not only by the SCPTM but also by the MBMS.

### Operation According to First Embodiment

Below, an operation according to the first embodiment will be described.

The eNB 200 according to the first embodiment transmits, by the SCPTM transmission, multicast data to a plurality of UEs 100 belonging to a UE group configured to perform group communication. The transmitter 210 of the eNB 200 transmits, to the UE 100 in the cell, group list information including a group identifier of each UE group currently being provided with group communication from a cell of the eNB 200. Specifically, the group list information includes a group identifier of each UE group performing group communication by SCPTM (hereinafter, appropriately referred to as “SCPTM group communication”) in a cell of the eNB 200. Here, the group identifier is a TMGI, a group RNTI, or the like, however, hereinafter, a case is mainly assumed where the group identifier is a TMGI.

The transmitter 210 of the eNB 200 transmits the group list information, by broadcast or unicast, in a cell of the eNB 200. In the broadcast, not only a UE 100 in the RRC connected mode, but also a UE 100 in the RRC idle mode is capable of receiving the group list information. Furthermore, the UE 100 not only receives the group list information from the serving cell, but the UE 100 is also capable of receiving the group list information from a neighbouring cell. Hereinafter, it is mainly assumed that the group list information is transmitted by broadcast. For example, the group list information is transmitted as part of system information by a broadcast RRC message.

The UE 100 that has received the group list information can comprehend SCPTM group communication performed in a cell (serving cell or neighbouring cell) from which the group list information is transmitted to determine whether or not desired group communication is provided. Further, by applying a notification for starting or continuing the desired group communication to the eNB 200, it is possible to improve service availability of the group communication.

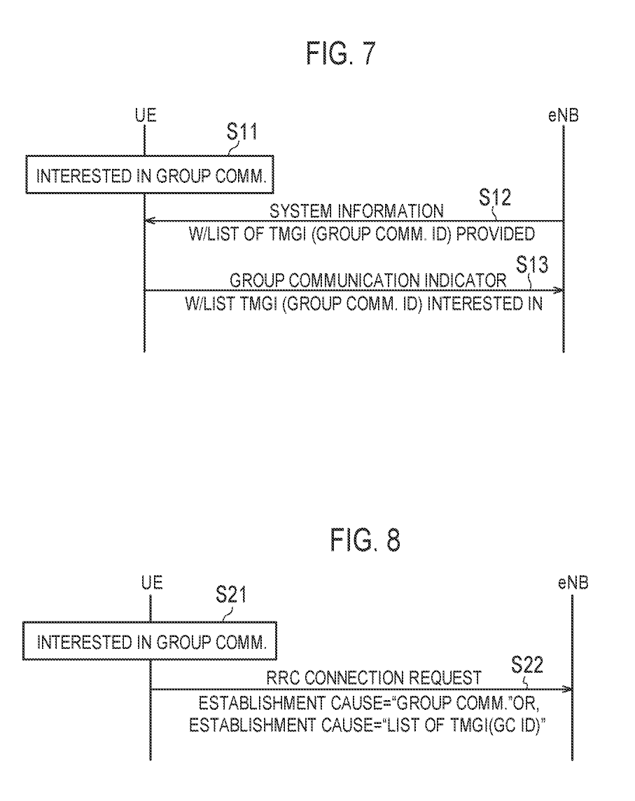

Operation patterns 1 and 2 for improving service availability of group communication will be described below. FIG. 7 is a chart for describing the operation patterns 1 and 2.

(1) Operation Pattern 1

As illustrated in FIG. 7, in step S11, the controller 130 of the UE 100 is interested in a group communication (group communication #1) corresponding to a TMGI #1. For example, it is determined that an application layer of the UE 100 starts the group communication #1 in response to a user operation, and an AS layer is notified of this determination. Alternatively, the UE 100 may be in a state where the group communication #1 is already performed. Hereinafter, “interested in group communication” includes a state where the group communication is already performed.

In step S12, the transmitter 210 of the eNB 200 transmits by broadcast group list information including a TMGI of each UE group configured to perform SCPTM group communication (SCPTM communication provided by a cell of the eNB 200) in the cell of the eNB 200. Here, the cell of the eNB 200 may be a serving cell of the UE 100 or a neighbouring cell.

The group list information may further include information indicating a frequency in which the group communication corresponding to the TMGI is provided.

The receiver 110 of the UE 100 receives the group list information transmitted from the eNB 200 (the serving cell or the neighbouring cell).

The controller 130 of the UE 100 determines, based on the group list information, whether or not the group communication (group communication #1) in which the UE 100 is interested in, is provided. Specifically, if the TMGI #1 is included in the group list information, it is determined that the group communication #1 is provided in the cell from which the group list information is transmitted. On the other hand, if the TMGI #1 is not included in the group list information, it is determined that the group communication #1 is not provided in the cell from which the group list information is transmitted.

The controller 130 of the UE 100 may make such a determination for each of the serving cell and the neighbouring cell. Alternatively, such a determination may be made only for the serving cell or only for the neighbouring cell.

Upon determining that the group communication in which the UE 100 is interested is not provided, the transmitter 120 of the UE 100 transmits a group communication interest notification (interest notification) to the serving cell (eNB 200) in step S13. In the operation pattern 1, the group communication interest notification is a notification indicating that the group communication in which the UE 100 is interested is not provided.

The group communication interest notification includes the TMGI (TMGI #1) corresponding to the group communication (group communication #1) in which the UE 100 is interested. If there are a plurality of group communications in which the UE 100 is interested, the group communication interest notification may include a plurality of TMGIs corresponding to the plurality of group communications. The receiver 110 of the eNB 200 receives the group communication interest notification.

In response to reception of the group communication interest notification, the controller 230 of the eNB 200 performs a control for providing the UE 100 with the group communication #1 in which the UE 100 is interested. For example, the controller 230 of the eNB 200 transmits information for starting a communication session of the group communication #1 to any one of the MME 300, the MCE 11, the GCS AS 31, the MBMS GW 21 and the BM-SC 22. The information includes at least one of, for example, an establishment request of an evolved packet system (EPS) bearer, a multicast/unicast request, information on data routing (an address, for example), the number of UEs in a cell of the eNB 200 (per TMGI, for example), and a preference of the eNB. Alternatively, the information may be a changeover request to MBMS. For example, if a usual MBMS is already in operation or started, or if a sufficient number of group communications are implemented where physical resources are sufficiently utilized if the group communication is transmitted by MBMS, a changeover to the MBMS may be requested. Alternatively, if UEs interested in a certain TMGI exceed a certain amount, the UEs interested in the TMGI may change over to the MBMS.

Furthermore, the controller 230 of the eNB 200 may determine whether or not to perform SCPTM transmission or unicast transmission to the UE 100. For example, if the cell of the eNB 200 is congested and there are a plurality of UEs 100 interested in the group communication #1, it is preferable to perform the SCPTM transmission. Alternatively, the controller 230 of the eNB 200 may determine whether or not to provide the group communication to the UE 100 depending on whether the cell of the eNB 200 is congested or not. Alternatively, the controller 230 of the eNB 200 may determine whether or not to hand over the UE 100. For example, if the group communication #1 is provided in the neighbouring cell and the group communication #1 is not provided in the cell of the eNB 200, the UE 100 may be handed over to the neighbouring cell.

It is noted that if the UE 100 has lost the interest in the group communication corresponding to the TMGI #1 after transmission of the group communication interest notification including the TMGI #1, the transmitter 120 of the UE 100 may transmit the TMGI #1 to the eNB 200.

Furthermore, it should be noted that even without a notification request from the network (eNB 200), the UE 100 transmits the group communication interest notification to the network.

(2) Operation Pattern 2

In the above-described operation pattern 1, upon determining, based on the group list information, that the group communication in which the UE 100 is interested is not provided, the UE 100 transmits a group communication interest notification to the serving cell (eNB 200).

On the other hand, in the operation pattern 2, upon determining, based on the group list information, that the group communication in which the UE 100 is interested is provided, the UE 100 transmits a group communication interest notification to the serving cell (eNB 200). That is, in the operation pattern 2, the group communication interest notification is a notification indicating that the group communication in which the UE 100 is interested is provided. In this case, the group communication interest notification is treated as a participation request for the desired group communication.

In the operation pattern 2, the eNB 200 that has received the group communication interest notification including the TMGI #1, determines whether or not to provide the group communication #1 corresponding to the TMGI #1 to the UE 100, and transmits the determination a determination result (a permission notification or a rejection notification) to the UE 100. The permission notification may be performed by an individual RRC message (RRC Connection Reconfiguration Message). The individual RRC message may include a reception parameter configuration of the group communication #1 (for example, the group RNTI or the like of the group communication #1).

The other operations are the same as those in the operation pattern 1.

It is noted that upon reception of the group communication interest notification, the eNB 200 may assign/configure the group RNTI corresponding to the TMGI included in the group communication interest notification, to the UE 100.

Furthermore, it should be noted that even without a notification request from the network (eNB 200), the UE 100 transmits the group communication interest notification to the network.

### Summary of First Embodiment

As described above, the UE 100 determines, based on the group list information, whether or not the desired group communication is provided in the serving cell or the neighbouring cell, and the UE 100 transmits the group communication interest notification to the eNB 200. Based on the group communication interest notification, the eNB 200 is capable of performing a control for starting or continuing the desired group communication. Therefore, it is possible to improve service availability of group communication.

### First Modification of First Embodiment

In the above-described first embodiment, the UE 100 transmits the group communication interest notification to the eNB 200. However, the UE 100 may transmit the group communication interest notification to a device different from the eNB 200, namely to a management device configured to manage the group communication. The management device is the MME 300, the GCS AS 31, the BM-SC 22, or the like, however, an example where the management device is the GCS AS 31 is described below. In this case, the group communication interest notification is transmitted from the UE 100 to the GCS AS 31 via a GC 1 interface between the UE 100 and the GCS AS 31.

In a first modification of the first embodiment, the group communication interest notification may include a cell identifier (and an eNB identifier) of the serving cell of the UE 100. Thereby, the GCS AS 31 is capable of comprehending a cell where the UE 100 exists in.

Furthermore, the group communication interest notification may further include information indicating that the group communication in which the UE 100 is interested is provided by the serving cell by the SCPTM transmission (or not provided by the SCPTM transmission). Thereby, the GCS AS 31 is capable of determining to use a multicast bearer for the SCPTM transmission, and a unicast bearer (EPS bearer) for non-SCPTM transmission. It is noted that the EPS bearer is a logical data path established between the UE 100 and the P-GW 23. A group communication bearer to which the SCPTM transmission is applied, may be established as the unicast bearer (EPS bearer). The eNB 200 may obtain a TMGI corresponding to the EPS bearer from the MME 300, the MBMS GW 21, or the MCE 11 and use the same in various types of controls.

### Second Modification of First Embodiment

In the above-described first embodiment, the UE 100 transmits, based on the group list information, the group communication interest notification. However, the UE 100 may transmit the group communication interest notification, without relying on the group list information.

The eNB 200 receives group communication interest notifications from a plurality of UEs 100 in the cell of the eNB 200, and tallies the number of interests for each TMGI, based on a TMGI included in the group communication interest notification. Then, the eNB 200 may determine for each TMGI whether to perform the unicast transmission or the SCPTM transmission, based on the number of tallied interests. In this case, the UE 100 may receive system information for MBMS (SIB 13/SIB 15), and transmit a group communication interest notification, based on a TMGI included in the system information for MBMS.

In the present modification, the GCS AS 31 performs a control of the bearer (the EPS bearer or the MBMS bearer); however, to configure so that the eNB 200 can comprehend data of which bear to be transmitted by the SC-PTM, any one of the following methods may be applied.

(1) When data on the EPS bearer can be transmitted by SC-PTM; (1-1) An EPS bearer capable of the SC-PTM transmission holds information (tag) to indicate the capability (tagged EPS bearer).

(1-2) The eNB 200 obtains a bearer ID of the EPS bearer capable of the SC-PTM transmission.

(1-3) An Aggregated EPS bearer to bundle EPS bearers is newly defined and established. The Aggregated EPS bearer includes a linked EPS bearer ID.

(1-4) The above-described information may be E-RAB information.

(2) When the data on the MBMS bearer can be transmitted by SC-PTM;

(2-1) The eNB 200 obtains a TMGI that can be transmitted by the SC-PTM.

(2-2) Similarly to the EPS bearer, the MBMS bearer is tagged.

(2-3) The eNB 200 obtains linking information (list) of a TMGI that can be transmitted by the SC-PTM and the MBMS bearer ID.

Here, it is assumed that the above-described bearer tagging is managed by the GCS AS, the P-GW, the S-GW, or the BM-SC, however, the bearer tagging may also be managed by the MME, the MCE, or the MBMS GW.

### Third Modification of First Embodiment

A TMGI list may be provided from the GCS AS 31 to the eNB 200 (or the MCE 11). The TMGI list provided from the GCS AS 31 may include a UE ID of a UE interested in (linked to) the TMGI. The UE ID may further be linked to at least one of: a cell ID, an eNB ID, and an MBMS area ID corresponding to the cell where the UE exists.

The eNB 200 (or the MCE 11), which does not manage a TMGI, obtains the TMGI list from the GCS AS 31 so that the eNB 200 can broadcast the above-described group list information. Further, instead of the above-described group communication interest notification, the eNB 200 (or the MCE 11) may comprehend the number of UEs corresponding to each TMGI, based on the TMGI list, and perform a changeover control among unicast, MBMS, and SC-PTM.

Alternatively, the TMGI list may be provided from the GCS AS 31 to the eNB 200 (or the MCE 11). The UE 100 becomes capable of SC-PTM reception without confirming MBMS control information (MCCH, SIB 13, SIB 15 and the like).

### Fourth Modification of First Embodiment

In the above-described first embodiment, the group list information transmitted from one cell includes the group identifier of each UE group configured to perform the SCPTM group communication in the one cell.

However, the group list information transmitted from one cell may include not only such a group identifier, but also a group identifier of each UE group configured to perform SCPTM group communication in a neighbouring cell.

Alternatively, the group list information transmitted from one cell may include a group identifier of each UE group configured to perform SCPTM group communication in a neighbouring cell, without including the group identifier of each UE group configured to perform the SCPTM group communication in the one cell.

Furthermore, the “neighbouring cell” in the present modification may be replaced with a “neighbouring frequency”.

### Fifth Modification of First Embodiment

As described above, the group communication includes not only the SCPTM group communication, but also group communication by MBMS (MBMS group communication).

Accordingly, in addition to a TMGI of each UE group configured to perform SCPTM group communication in the cell of the base station, the group list information may further include a TMGI of each UE group configured to perform MBMS group communication. In this case, the group list information may further include information indicating whether the SCPTM transmission or the MBMS is applied to the group communication corresponding to the TMGI.

### Second Embodiment

A second embodiment will be described while focusing on the differences from the first embodiment. The second embodiment relates to an embodiment relating to an operation in which the UE 100 establishes a connection with the eNB 200 for starting group communication.

### Operation According to Second Embodiment

Below, an operation according to the second embodiment will be described. FIG. 8 is a chart for describing an operation according to the second embodiment. In an initial state of FIG. 8, the UE 100 is in the RRC idle mode.

As illustrated in FIG. 8, in step S21, the controller 130 of the UE 100 has an interest in group communication and determines to connect to the eNB 200 to obtain configuration information (such as a group RNTI) related to the group communication. Alternatively, the UE 100 is in a state of already performing group communication by SCPTM transmission, and may move out of an SCPTM service area and determine to connect to the eNB 200 to change over from the SCPTM transmission to unicast transmission.

In step S22, the transmitter 120 of the UE 100 transmits to the eNB 200 a connection request message (RRC Connection Request Message) for transitioning from the RRC idle mode to the RRC connected mode. Upon transitioning to the RRC connected mode in connection with the group communication, the controller 130 of the UE 100 includes information on the group communication into the connection request message.

The connection request message includes a field indicating a connection reason (Establishment Cause). The controller 130 of the UE 100 includes information indicating the group communication, into this field. Furthermore, the controller 130 of the UE 100 includes, a TMGI corresponding to the group communication in which the UE 100 is interested, into the connection request message.

The receiver 220 of the eNB 200 receives the connection request message from the UE 100. If the information on the group communication is included in the connection request message, the controller 230 of the eNB 200 performs a control for the group communication. For example, in much the same way as in the above-described first embodiment, the eNB 200 performs a control for providing the UE 100 with the group communication in which the UE 100 is interested.

### Summary of Second Embodiment

Upon transitioning to the RRC connected mode in connection with the group communication, the UE 100 includes the information about the group communication into the connection request message (RRC Connection Request Message). Thereby, the eNB 200 comprehends that the message is a connection request for the group communication, and it is possible to immediately implement the appropriate control.

### Other Embodiments

In the above-described first embodiment and second embodiment, the communication between eNBs 200 was not specifically described. However, the eNB 200 may preserve the group communication interest notification (the TMGI in which the UE 100 is interested) received from the UE 100, and transfer the group communication interest notification to a target eNB when the UE 100 is handed over. Thereby, the target eNB is capable of appropriately providing the group communication to the UE 100.

In the above-described first embodiment and second embodiment, the LTE system is exemplified as the mobile communication system. However, the present disclosure is not limited to the LTE system. The present disclosure may be applied to systems other than the LTE system.

### APPENDIX

### Introduction

Single-cell PTM (SC-PTM) transmission has been proposed in the new study item as a means to improve radio efficiency for critical communication. Although the intention is to reuse the existing eMBMS/GCSE architecture as much as possible, it is still necessary to clarify which entity is in charge of selecting the SC-PTM mechanism as the choice for data delivery. This appendix discusses the various alternatives that should be considered for such a selection.

(Current Architecture for GCSE)

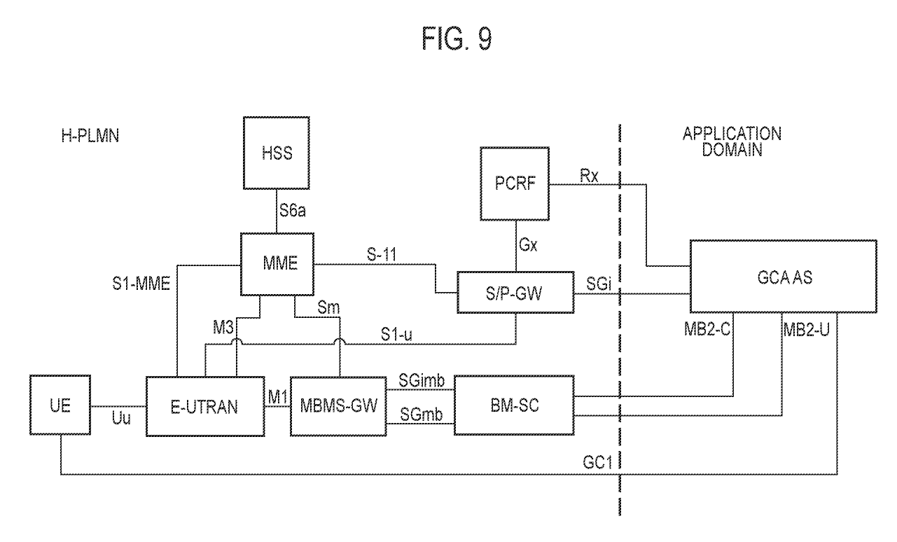

FIG. 9 shows a high level view of the current architecture for the Rel-12 GCSE.

The current specification assumes that the GCS AS will decide whether the data should be delivered via Unicast or MBMS and it may dynamically decide to use an MBMS bearer service when it determines that the number of UE for a GCS group is sufficiently large within an area (e.g. within a cell or a collection of cells). When MBMS bearer service is used, GCS AS may transfer data from a GCS group over a single MBMS broadcast bearer. When the GCS AS decides to deliver data over Unicast, this is done through the established EPS bearer, where signaling between the GCS AS and the UE, uplink data and downlink data may be transported.

With the approved SC-PTM study item, the focus is on the study of a technical solution for radio efficiency enhancements in E-UTRAN. In particular, one of the objectives of the work item is for the UE to receive the DL multicast over PDSCH that is intended for a group of users with common interests. However, before considering the enhancement needed for E-UTRAN, there should be a common understanding on what is expected from the GCS AS, BM-SC, their interactions with the E-UTRAN and any possible signaling needed to support the SC-PTM transmissions. In particular, it is necessary to understand which entity or entities should decide when SC-PTM should be utilized.

Observation: It is necessary to clarify which entity or entities are responsible for determining whether SC-PTM should be used for group communications.

(Selection of SC-PTM Transmission)

With SC-PTM as the new delivery mechanism it should first considers whether this delivery mechanism is decided by the GCS AS or some other entity. If the selection of SC-PTM as the delivery mechanism is decided by the GCS AS then some additional signaling towards the MCE or the S/P-GW may be needed; whereas if the GCS AS does not directly determine the use of SC-PTM, then the decision should be decided by other network entities.

(Selection of SC-PTM Transmission by GCS AS)

If the GCS AS directly selects the SC-PTM, this means the GCS AS would need to decide whether data should be delivered to the UE via Unicast, MBMS or SC-PTM. The current assumptions in the Rel-12 and Rel-13 GCSE assumes the UE may report its location information and interest information to the network, so that traffic data could be routed towards the appropriate cell that UE locates. So if the interest and location information are both available to the GCS AS, then it may be possible for the GCS AS to determine whether SC-PTM should be selected for data delivery.

However, even if it is the GCS AS entity that decides whether SC-PTM should be used for data delivery, it is still necessary to decide how this information will be conveyed to the E-UTRAN since the delivery of the data via SC-PTM transmissions may be based on either PDSCH or PMCH.

If the GCS AS treats SC-PTM transmission as a MBMS-type service and the UEs receive multicast over the PMCH, then it is reasonable to assume that the GCS AS should inform the BM-SC of its intent to use SC-PTM as the delivery mechanism. Then it is up to the BM-SC to inform the E-UTRAN (through the MB2-C interface) that SC-PTM transmission should be used for data delivery.

Proposal 1: If the GCS AS considers SC-PTM as an MBMS-like mechanism using PMCH, it should be possible for the GCS AS to inform the E-UTRAN of the intent to support SC-PTM through the MB2-C interface.

Alternatively, if the SC-PTM transmission is over PDSCH, the GCS AS may also consider SC-PTM as a collection of Unicast services for multiple UEs and inform the E-UTRAN through the S/P-GW of its desire to use SC-PTM transmissions. Since the resources for PDSCH is controlled by the E-UTRAN, it is conceivable that the control of the delivery mechanism could also be decided by the E-UTRAN regardless of whether it is for one UE or multiple UEs within a serving cell. Therefore, from the perspective of the GCS AS, as long as the data is not to be delivered by MBMS and the GCS AS may bypass the BM-SC and inform the E-UTRAN of the need to support data delivery. More specifically, the GCS AS may have the following two options:

Option A-1: The GCS AS informs E-UTRAN of the need to support SC-PTM transmission.

Option A-2: The GCS AS informs E-UTRAN of the need to delivery data, but the decision of whether to use SC-PTM or Unicast transmission is left for the E-UTRAN to decide.

With Option A-1, since the GCS AS explicitly informs E-UTRAN of the need to support SC-PTM transmission, the data delivery should only be carried out based on SC-PTM and not Unicast and vice versa. Due to the dynamic radio condition and load condition at E-UTRAN, it may not always be possible to apply the transmission mechanism instructed from GCS AS which may lead to reduced efficiency at the radio interface since service continuity must not be compromised.

With Option A-2, the E-UTRAN would decide between SC-PTM transmission and Unicast transmission. Considering the issue with RRM and the need to support frequent handovers, the choice of the delivery mechanism over the PDSCH should be controlled by E-UTRAN and not the GCS AS. With Option A-2, a new mechanism may be needed for the serving cell to collect the necessary information from its UEs (e.g., TMGI interest indication).

Proposal 2: If the UE receives DL multicast by PDSCH and the GCS AS considers SC-PTM as a Unicast-like mechanism, the choice between SC-PTM and Unicast should be controlled by E-UTRAN (Option A-2).

(Selection of SC-PTM Transmission by BM-SC/MCE)

From a different perspective, since SC-PTM transmission is not unlike MBMS in that it is a form of a multicast delivery mechanism, it may be possible for the BM-SC to decide whether data should be delivered via MBMS or SC-PTM transmissions. This means the GCS AS may function the same as in Rel-12, and only decides between Unicast and MBMS (i.e., SC-PTM is mapped to MBMS). If the GCS AS determines that many UEs are interested in the same service it may inform the BM-SC of the need to deliver the data via MBMS.

Once the BM-SC is informed of the need to deliver data, it should decide whether the data should be delivered by MBMS or SC-PTM. In order for the BM-SC to determine which delivery mechanism to use, it will need some feedback from the interested UE. In particular, the BM-SC needs to determine whether the UEs belong to the same cell or multiple cells. If the interested UEs are from multiple cells then it may be more efficient to use MBMS whereas if the UEs are all from one cell, then the choice may be for SC-PTM transmissions. To obtain the location information of UEs, one of the following three options may be considered:

Option B-1: The BM-SC may obtain the location information from the GCS AS.

Option B-2: The BM-SC in coordination with the MCE may obtain the location information using a mechanism similar to Counting Request.

Option B-3: The BM-SC may request E-UTRAN to determine the number of UEs served by the same cell.

With Option B-1, it is assumed that the GCS AS will be able to obtain the UE's location information through the application layer so this information may be shared with the BM-SC. Considering the possibility of frequent handovers especially with the deployment of many small cells, it should be considered how often the UE needs to provide updates to its current location.

With Option B-2, the BM-SC could coordinate with the MCE to use a method similar to the Counting Request to determine how many UEs are interested in the same service belonging to the same cell. The advantage of this approach is that much of the existing mechanism for MBMS may be reused.

With Option B-3, a new mechanism will be needed for the serving cell to collect the necessary information from its UEs (e.g., TMGI interest indication). The collected information may be transferred to the BM-SC but it may also be necessary to transfer to the target cells to support service continuity since it cannot be assumed that neighbour cells would also broadcast the same content using SC-PTM as in the case for MBMS.

Proposal 3: If the BM-SC selects SC-PTM, how the BM-SC decides between MBMS and SC-PTM should be further clarified.

(Support for SC-PTM within the GCSE_LTE architecture) As discussed above, several of the options and proposals above involve changes to the inter-node signaling within the GCSE_LTE architecture. The decision on what changes may be needed should not be considered independently of the radio aspects in the E-UTRAN. In particular, if SC-PTM is realized through PDSCH rather than PMCH, the E-UTRAN should have direct control over the use of SC-PTM.

(Conclusion)

With the addition of the SC-PTM transmission mechanism, it is necessary to determine the overall structure of how SC-PTM transmission may be selected. In particular, the decision for using SC-PTM transmission may rest with the GCS AS, BM-SC, E-UTRAN or a combination of the entities.

### INDUSTRIAL APPLICABILITY

The present application is useful in the field of communication.

1. A base station comprising:
a processor and a memory coupled to the processor, the processor configured to execute processes of:
transmitting to a user terminal, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission;
receiving from the user terminal, interest notification including a first identifier corresponding to a first MBMS service which the user terminal is interested to receive, wherein the first MBMS service is determined by the user terminal based on the information; and
transmitting, when the user terminal is handed over from the base station to another base station, the interest notification to the another base station.

2. A user terminal comprising:
a processor and a memory coupled to the processor, the processor configured to execute processes of:
receiving from a base station, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission;
determining, on the basis of the information, whether or not a first MBMS service which the user terminal is interested to receive is provided; and
transmitting to the base station, interest notification including a first identifier corresponding to the first MBMS service upon determination that the first MBMS service is provided.

3. An apparatus provided in a user terminal, comprising:
a processor and a memory coupled to the processor, the processor configured to execute processes of:
receiving from a base station, information including an identifier corresponding to at least one MBMS (Multimedia Broadcast Multicast Service) service that is provided in a neighbor cell of a cell managed by the base station, wherein the at least one MBMS service is provided by using SCPTM (Single Cell Point To Multipoint) transmission;
determining, on the basis of the information, whether or not a first MBMS service which the user terminal is interested to receive is provided; and
transmitting to the base station, interest notification including a first identifier corresponding to the first MBMS service upon determination that the first MBMS service is provided.
